(19) United States
(12) Patent Application Publication
(10) Pub. No.: US 2016/0140289 A1
(43) Pub. Date: May 19, 2016

(54) VARIANT CALLER

(71) Applicant: Counsyl, Inc., South San Francisco, CA (US)

(72) Inventors: Andrew Leonidovich GIBIANSKY, Claremont, CA (US); Imran Saeedul HAQUE, San Francisco, CA (US); Jared Robert MAGUIRE, San Francisco, CA (US); Alexander De Jong ROBERTSON, San Francisco, CA (US)

(21) Appl. No.: 14/884,656

(22) Filed: Oct. 15, 2015

Related U.S. Application Data
(60) Provisional application No. 62/064,717, filed on Oct. 16, 2014.

(51) Int. Cl. G06F 19/22; G06N 3/12; G06N 7/00

(52) U.S. Cl. CPC G06F 19/22; G06N 7/005; G06N 3/126

(57) ABSTRACT

Processes and systems for reading variants from a genome sample relative to a reference genomic sequence are provided. An exemplary process includes collecting a set reads and generating a k-mer graph from the reads. For example, the k-mer graph can be constructed to represent all possible substrings of the collected reads. The k-mer graph may be reduced to a contiguous graph, and a set of possible haplotypes generated from the contiguous graph. The process may further generate, the error table providing a filter for common sequencer errors. The process may then generate a set of diplotypes based on the set of haplotypes and the generated error table and score the set of diplotypes to identify variants from the reference genome. Scoring the diplotypes may include determining a posterior probability for each of the diplotypes, with the highest scoring diplotype(s) reported as the result.

### CROSS-REFERENCE TO RELATED APPLICATIONS

This application claims priority to U.S. Provisional Application No. 62/064,717, filed on Oct. 16, 2014, entitled “VARIANT CALLER,” the content of which is hereby incorporated by reference in its entirety for all purposes.

### FIELD

This relates generally to processes and systems for identifying and quantifying variants in DNA sequencer reads, and in one example, to a variant caller process and system for identifying variants from a reference genomic sequence through the use of an error table to remove haplotype errors and then generating and scoring diplotypes (pairs of haplotypes) to determine variants.

### BACKGROUND

Variant callers generally determine that there is a nucleotide difference in a DNA sequence read relative to a reference genomic sequence. There are several known variant callers, including those known as Platypus, the Genome Analysis Toolkit “GATK”, and Freebayes. Platypus, for example, is a system for variant detection in high-throughput sequencing data that relies primarily on local realignment of reads and local assembly thereof. Platypus is described in greater detail in “Integrating mapping-, assembly- and haplotype-based approaches for calling variants in clinical sequencing applications,” which is incorporated herein by reference in its entirety.

### SUMMARY

In one example, a computer-implemented process for reading variants from a genome sample relative to a reference genomic sequence is provided. The process includes collecting a set of reads and generating a k-mer graph from the reads. For example, the k-mer graph can be constructed to represent all possible substrings of the collected reads. The k-mer graph may be reduced to a contiguous graph, and a set of possible haplotypes generated from the contiguous graph. The process may further generate an error table (e.g., from many previous samples to identify common sequencer errors), which provides a filter for common sequencer errors. The process may then generate a set of diplotypes based on the set of haplotypes and the error table and score the set of diplotypes to identify variants from the reference genome. Scoring the diplotypes may include determining a posterior probability for each of the diplotypes, with the highest scoring diplotype(s) reported as the result.

In another example, a computer-implemented process for generating an error table of sequence data is provided. The exemplary process may include, at an electronic device having at least one processor and memory, determining a set of possible haplotypes from a set of collected reads from a genome sample, aligning the set of collected reads to a reference sample, determining sites where a read of the set of collected reads has a mismatch from the reference sample, and adding sites that have a mismatch to an error table. Determining the set of possible haplotypes may include generating a k-mer graph from the set of collected reads, reducing the generated k-mer graph to a contiguous graph, and determining the set of possible haplotypes from the contiguous graph.

Additionally, systems, electronic devices, graphical user interfaces, and non-transitory computer readable storage medium (the storage medium including programs and instructions for carrying out one or more processes described) for variant callers and generating error tables are described.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates an exemplary calling process according to one embodiment.

FIGS. 2A-2C schematically illustrate exemplary processes described with reference to the process of FIG. 1.

FIGS. 3A and 3B illustrate plots of different read models.

FIG. 4 illustrates an exemplary system and environment in which various embodiments of the invention may operate.

FIG. 5 illustrates an exemplary computing system.

### DETAILED DESCRIPTION OF THE INVENTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

This relates generally to a variant caller for identifying variants from a reference genomic sequence. In one example, the variant caller includes a process for generating an error table to remove errors from haplotypes, generating diplotypes, and scoring the diplotypes to identify variants from a reference genomic sequence. Examples of the variant caller may provide several advancements over known callers such as Platypus, GATK, Freebayes, and others. For instance, although not present in every embodiment or example, advancements may include localization instead of alignment in reads (e.g., instead of piling up reads for alignment, use all reads to create one graph) and error calibration via an error table to guard against common sequencer errors.

In one embodiment, a variant caller is divided into several processing stages, with each stage providing its output as input to the next stage. The below example assumes the use of Binary Alignment/Map format “bam” or “BAM” format, which is a binary format for storing sequence data; however, other data formats (e.g., Sequence Alignment/MAP format or “SAM” format) are contemplated and possible. In one example, the processing of each region in each bam file is entirely separate from all other regions and bam files.

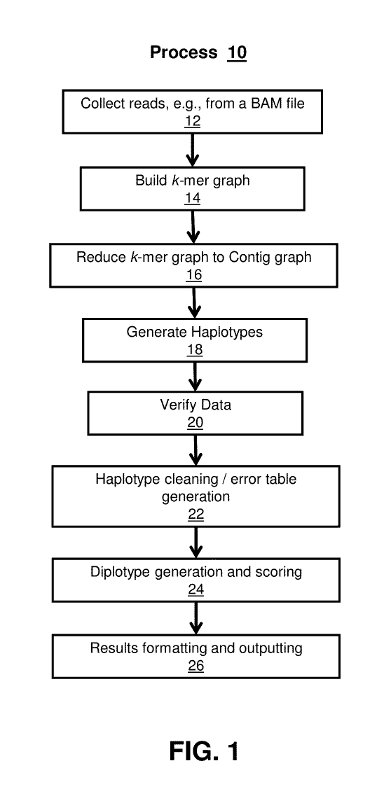

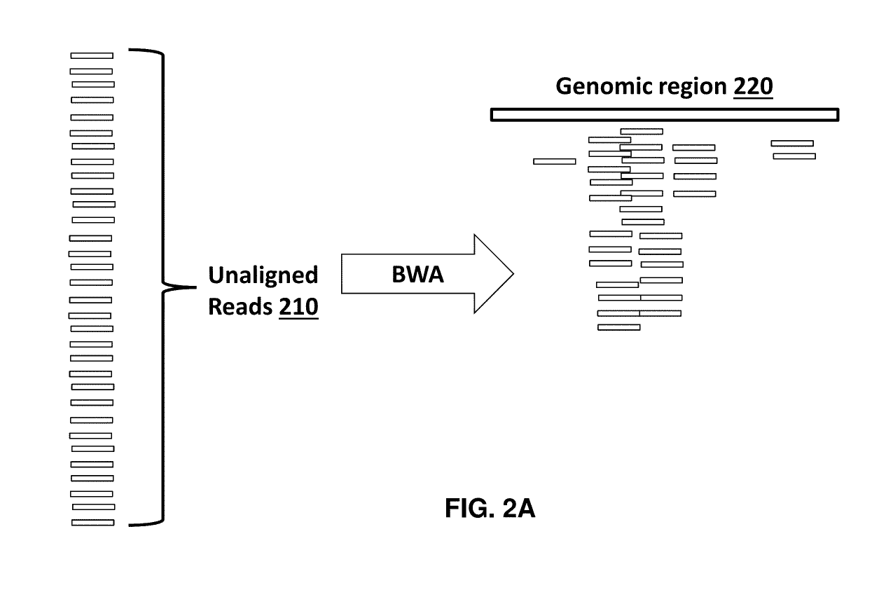

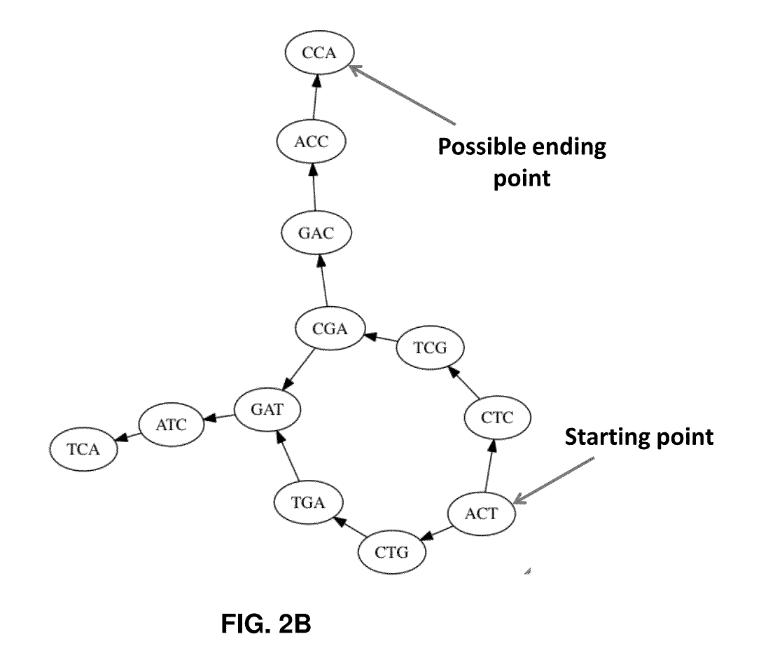

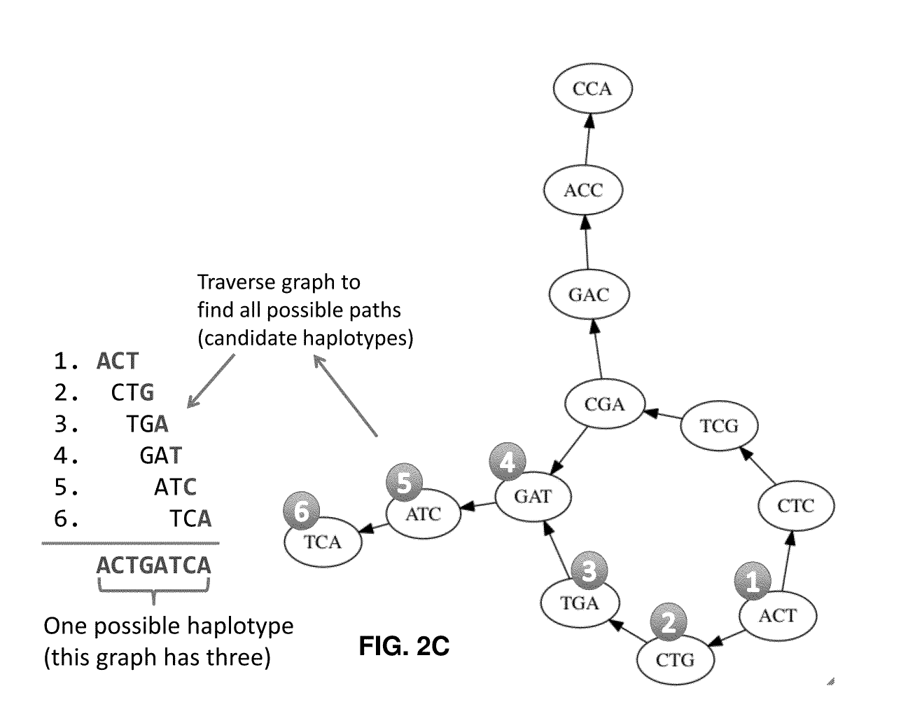

Broadly speaking, and in one example, to generate a call for a region, the following process is performed, which is illustrated as process 10 in FIG. 1. In conjunction with the description of process 10, FIGS. 2A-2C will be referenced to schematically illustrate various aspects of process 10.

Initially, sequences of interest are obtained at 12. For example, reads can be collected from the bam file that overlap with the region of the call in any way. The processing may include using a short-read aligner, such as BWA, BOWTIE, MAX, etc., to align reads 210 to a genomic region 220 as illustrated schematically in FIG. 2A. The collected reads can then be clipped using their associated soft-clipping information. Auxiliary information from the aligner, e.g., base-to-base alignment information, can then be discarded, and the reads become simply a sequence of bases. (In some examples, filtering based on mapping quality can be optionally performed.)

A k-mer graph is then built at 14 from the collected reads, the k-mer graph representing all possible substrings, of length k, that are included with the collected reads. An exemplary k-mer graph is illustrated in FIG. 2B, where k=3 (in practice a k between 20 and 30 may be used to ensure that the k-mers are unique, e.g., happen only in one place). For example, each read is scanned through to collect k-mers and k-mer transitions. Each edge is annotated with its associated probability of transition and each k-mer is annotated with the number of times it is seen as the origin of an edge. The probability of transition between k-mers A and B is the number of times k-mer B following k-mer A is seen divided by the number of times k-mer A is seen in total.

The k-mer graph can then be reduced to a contiguous (“contig”) graph at 16 for simplicity of processing. A contig graph generally illustrates a set of overlapping segments that together form a region of genomic information. For example, this step can join two k-mers if they always end up in the same path. In addition, the k-mer graph is filtered by discarding any k-mer that is seen less than a threshold number of times (e.g., less than four times) and discarding any edge that has a probability lower than a threshold (e.g., lower than 3%). Once the k-mer graph is created, it can be checked for cycles, i.e., paths that converge on themselves. If the graph has cycles, it can be discarded, k increased, and the graph re-built. Thus, in this example, the k-mer graph will be built without cycles.

Haplotype generation can then be performed at 18. For example, once the contig graph is built, starting points for haplotype candidates can be found by looking at all contigs with no incoming edges (in-degree 0). These should be contigs at the beginning of a region, though contigs in the middle of the region can also have this property if they were created due to noise. Then, taking those contigs as starting points, all possible paths through the contig graph are enumerated, with each path ending once it reaches a contig with no out-going edges (a dead end). Before moving on, all the paths can be turned into haplotype strings by joining their contigs. A simplified example is illustrated in FIG. 2C, with a starting point indicated by “1” and running to “6”. Each possible path generates a possible haplotype, one of which is shown in the figure.

Once a set of possible haplotypes are generated, the exemplary process verifies (through one or more heuristics) that it has enough data to make a sufficiently good call at 20. For example, the process checks that each position in the desired region is covered by enough k-mers, and that there exists at least one haplotype that covers the entire region. If any of these checks fail, a no-call can be emitted for the entire region. It should be understood, that the heuristics can be adjusted for the desired confidence in the call.

The set of possible haplotypes can further be “cleaned” at 22 before any scoring process. The haplotypes that are generated from the contig graph are generally not suitable for output or scoring. Accordingly, in one example, before scoring, they go through several correction phases. First, the haplotypes are clipped to the region of interest; since the caller uses all overlapping reads, most haplotypes will originally extend beyond the edges of the region in question. In one example, to clip the haplotype, it is aligned to the region in question, and any bases outside the alignment are discarded. Once haplotypes are clipped, errors in the haplotype can be corrected. For example, the process can generate an error table (described in greater detail below) from many samples that lists common sequencer errors, and this error table can be used to remove those errors from a set of possible haplotypes. These steps may result in a set of haplotypes that include duplicates, and the duplicates can be dropped.

Diplotypes can be generated from the haplotypes and scored at 24. For example, the set of N haplotypes can be combined with itself in order to generate all possible diplotypes. For N haplotypes, there will be N(N+1)/2 unique diplotypes. These diplotypes can then be scored, where the score of a diplotype is equal to its posterior probability, P(diplotype|reads). The highest-scoring diplotype can be reported as the result, with the confidence equal to the log of the ratio between the winning probability and the next best probability. The Diplotype scoring is described in greater detail below.

The results can then be formatted (if needed) and written out as requested at 26. For example, if the formats are JavaScript Objection Notation (“json” or “JSON”) or Variant Call Format (“vcf-full”, no extra processing is necessary in this example, and the call is simply written out to disk. However, if the result format is Variant Call Format-Single Nucleotide Polymorphism (“vcf-snp”), the results are broken up into smaller calls, which break up a region into its individual SNPs and indels. A single call in the vcf-snp format consists of all variation where the different variants are within some distance of each other (e.g., 10 bases).

Diplotype Scoring

In one example, the above mentioned set of N haplotypes can be combined with itself in order to generate all possible diplotypes. For N haplotypes, there will be N(N+1)/2 unique diplotypes. These diplotypes are then scored; the score of a diplotype is equal to its posterior probability, P(diplotype|reads). The highest-scoring diplotype can be reported as the result, with the confidence equal to the log of the ratio between the winning probability and the next best probability.

An exemplary probabilistic scoring model used to determine the best diplotype out of a list of candidates will now be described. In one example, the score assigned to each diplotype is the posterior probability of the diplotype, P(diplotype|reads). Since the probabilities used for scoring are typically small, in one implementation log-probabilities are used. The posterior probability can be decomposed into a likelihood and a prior:

P(diplotype|reads)=(1/Z)P(reads|diplotype)P(diplotype),

where Z=P(reads) is some normalization constant, which is not computed. Since Z is independent of diplotype, it can be disregarded for the purposes of comparing two diplotypes. The prior, P(diplotype), and the likelihood, P(reads|diplotype), can then be computed separately.

In order to compute the prior, it can be assumed, in this example, that most regions are similar to the reference. The probability of a diplotype is then the probability that the diplotype was generated via a biological mutation from the reference. This example assumes that this is simply the product of probabilities of the haplotypes being generated from the reference (which should be understood to not be entirely accurate due to selection, but generally sufficient). Thus, the probability of a diplotype can be expressed as:

P(diplotype)=P(haplotype_1)P(haplotype_2)

The probability of a haplotype being generated is the sum of the probabilities of it being generated in all the possible ways, where each possible alignment of the haplotype to the reference corresponds to a different way of generating the haplotype. However, doing a sum over all alignments can be computationally intractable, so this example assumes that the majority of the probability mass is contained in a single alignment, the one that has the highest probability. Thus, in order to compute P(haplotype), the process aligns the haplotype to the reference. The match, mismatch, gap-open, and gap-extend parameters used during alignment correspond to log-probabilities of those events happening due to biological mutations. Since alignment maximizes the score, it will maximize the log probability, thus yielding the highest-probability alignment. For instance, a one-base change happens approximately every thousand bases, so the mismatch parameter will be log(1/1000).

The computation of the likelihood P(reads|diplotype) uses a similar process. First, the example assumes that all reads are independent, which allows the likelihood to be rewritten as:

P(reads|diplotype)=product_i{P(read_i|diplotype)}

Then, the example assumes that a read can come either from the two haplotypes of a diplotype (with equal probability) or that it could be generated randomly from somewhere else in the genome (with very low probability). The second case effectively models aligner error and rare outliers. Thus, the probability of a read can be expressed as:

P(read|diplotype)=epsilon P(read is random)+(0.5−epsilon)P(read|haplotype_1)+(0.5−epsilon)P(read|haplotype_2).

The probability of a read being randomly generated is equal to each base being generated; since there are four equally likely bases:

P(read is random)˜=0.25 ̂len(read).

The probability of a read given a haplotype can be found using alignment. This example assumes that the haplotype is the true sequence of the underlying genome, and that the read is generated from this sequence using an errorful sequencing process. Thus, the alignment parameters should be the rates of sequencer error; the mismatch parameter, for instance, should be the log of the probability that a sequencer makes a one base change at an arbitrary base. Like with the prior, the process computes the best alignment, and uses the score as the probability.

It should be understood by those of ordinary skill in the art that other scoring processes may be used instead of or in addition to that described here, e.g., including other parameters, values, assumptions, and computational processes.

Error Table Generation

Generally, and in one example, the error table acts like a filter to guard against common sequencer error, which can make some regions very difficult to call otherwise. In one example, in order to generate the error table, several hundred (for example, 100-300, or more) samples that contain data for the same region are used. In this example, error table generation for a given region goes through the following steps:
1. For each sample, align the reads to the reference. For each base in the reference, count the number of times different variants are seen there (variants being the four bases, different length deletions, and different insertions). This process can be done separately for the forwards and backwards reads.
2. Find sites where there is more than some threshold of variation, that is, where more than some threshold percent of reads have a non-reference allele. For example, the threshold can be 1%. These sites are candidate sites to go into the error table.
3. Next, the error table sites are filtered. Exemplary steps in filtering will be described in greater detail below, in the next section.
4. The filters remove some of the sites from the error table. After the filtering, the sites are compared to Single Nucleotide Polymorphism Database “dbSNP” (and potentially multiple dbSNP Variant Caller Formats “VCFs”). Any sites that occur in dbSNP and are common can be removed from the error table.
5. The error table is written to disk as a large JSON file, where the record for each site indicates the reference base and the frequency of each alternate base. Any alternate bases with frequency greater than, e.g., 1%, may be filtered. The cutoff for filtering can be configurable in the system itself, so being in the error table is not enough to guarantee filtering. However, the cutoff is fairly similar. For example, the process can filter anything with greater than 1.5% frequency that is in the error table.

The error table can be generated once per region of interest and then stored for later use.

Error Table Filtering Statistics

As mentioned in step 3 (above) of the error table generation process, high-variance sites are all candidates for the error table. Candidate sites can be filtered out through a series of statistical tests (as well as through comparison to dbSNP). The following describes an exemplary procedure used for filtering the candidate error table sites, including two exemplary tests.

First, for each site, a Hardy-Weinberg test statistic can be computed. This can be done by very naive genotyping: for example, if a base is seen in a sample less than 20% of the reads, it is considered homozygous reference (“HOM REF”); if it is seen between 20% to 75% of the reads it is considered heterozygous (“HET”); if it is seen greater than 75% of the reads it is considered homozygous alternate (“HOM ALT”). Then, the samples are binned in to these three categories (HOM REF, HET, and HOM ALT), and a Hardy-Weinberg test is done using the standard Chi-Squared statistic against an alpha of 0.5%. Thus, if there is a chance that this site in the error table could have come from a real SNP, it is considered for removal from the error table.

However, these sites are not immediately removed from the error table in this example. In order to be removed from the error table, they must also pass a Bayes factor test. The Bayes factor test computes the ratio of probabilities of the data given two different models, an SNP model and a noise model, as follows:

B=P(data|SNP model)/P(data|noise model)

If the Bayes factor is high (e.g., greater than 10), the data has a higher probability of being from the SNP model, and thus the site is removed from the error table.

The two models are models of the read fraction distributions. If the frequency of an allele is 20%, the allele may be noise, and the distribution of frequencies in the samples will all be around 20% —that is, in each sample, about 20% of the reads will have this allele. Alternatively, the allele may be real, in which case some samples will have close to 100% of the allele, some samples will have 0%, and some samples will have 50% (corresponding to HOM ALT, HOM REF, and HET).

These two models have a different number of parameters. Generally, in the noise model the probability of observing noise in a read (which corresponds to the observed allele frequency) is needed, and in the SNP model, the probability of HOM ALT, HOM REF, and HET samples (which only two parameters, since these two must sum to one) is needed. In order to compare models with different numbers of parameters, the parameters can be integrated out. Thus, to compute P(data|noise model), the process can integrate P(data|noise model, noise probability) over all possible values of the noise probability (from 0 to 1). Similarly, in order to compute P(data|SNP model) the process can integrate P(data|SNP model, hom ref proportion, het proportion) over all possible values of the hom ref and het proportions (the hom alt proportion is one minus those two). (The area of integration is constrained such that the sum of those three is exactly one and none of them are outside the [0, 1] range.) This integration can be implemented using Scientific Python “SciPy” numerical integration functions (or equivalent).

Both of the models (the noise and SNP model) are based on the assumption that reads are being taken from some sort of Bernoulli distribution; either the process sees the allele in question, or it does not, with some probability p. For the noise model, the p is the parameter (the noise probability), and the process integrates over that p. The probability P(data|noise model, p) can be computed by using the binomial distribution probability mass function, where p is the probability the process is seeing the allele in question. The x and n parameters to the PMF are simply how many times that allele was seen and how many reads total in the sample. This allows for computing the probability of a given sample, and multiplying all those probabilities together over all the samples in the dataset provides the overall probability of the model given a parameter p. (Note: In order to avoid underflow in the exemplary calculations, the process may multiply each probability by 10; thus, the probability computed is scaled by 10̂N, where N is the number of samples in the data set.)

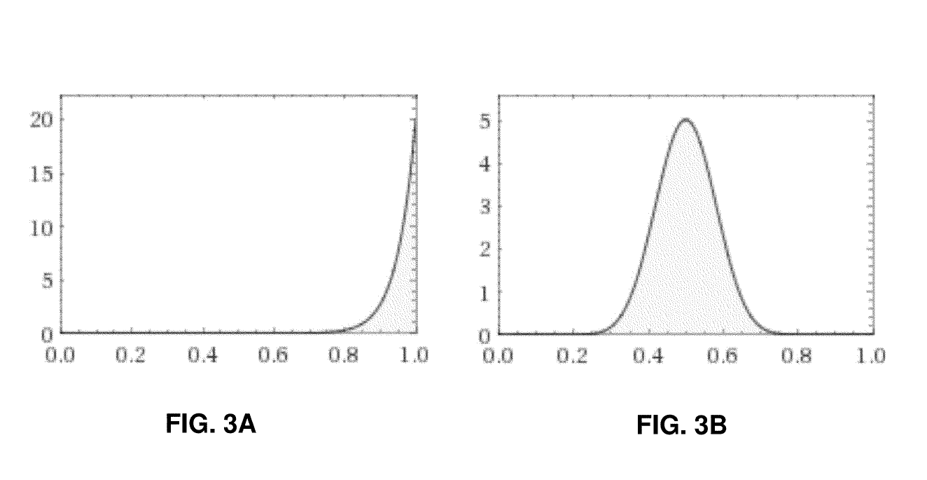

For the SNP model, the exemplary process includes three binomial distributions, one for the chance that the sample is HOM REF, one for HET, and one for HOM ALT. However, in each case, the process does not know the probability p, because even if the sample is a HOM REF or a HOM ALT, contamination could still yield some reference. Similarly, for the case of a HET, contamination and other effects (such as mapping quality) could yield a p that is not exactly 50%. To combat this, the process may let p be a random variable with a beta distribution; integrating over all possible values of p gives the beta-binomial distribution, which can be used instead of a simple binomial in these three cases in the SNP model. In order to model the prior information (that is HOM REF, HET, or HOM ALT), the process can use alpha and beta parameters for the beta prior that appropriately skew our distributions. For the HOM REF and HOM ALT cases the process and use alpha=20 and beta=1 (or vice versa), which yields a plot like that shown in FIG. 3A. For the HET case the process can use alpha=20 and beta=20, which yields a plot like that shown in FIG. 3B.

Any sites that fail the Bayes factor test are assumed to be noise that happens to be in Hardy-Weinberg proportions, and is thus kept in the error table.

In addition to the Bayes factor test, and in one example, in order for a site to be kept from the error table, it must pass a Strand Bias test. The Strand Bias test is fairly straightforward: the reads for the reference and for the allele are aggregated over all the samples, while keeping track of which strand the counts are on. The overall allele frequency p is also computed. Then, compute the probability of the forward reads (assuming that they come from a binomial distribution with probability p), and compute the same probability for the backward reads. If the ratio of those probabilities is very high or very low, it indicates that the distribution of the alleles is very biased towards one strand or the other. Thus, if the log of that ratio has magnitude greater than some threshold (e.g., greater than 10), the site is deemed strand biased and included in the error table.

Accordingly, in one example, if a site passes the Hardy-Weinberg test, the Bayes factor test, and the Strand Bias test, then it is removed from the error table candidate sites.

It should be recognized that various other tests, or combination of tests, may be employed to generate (or filter) the error table. Further, other variables or thresholds may be employed with the examples described herein to determine differences between sequencer errors and real variations.

Command-Line Interface:

The following sections describe the practical installation and usage of an exemplary variant caller and tools that may be provided with it. The exemplary variant caller described herein can be implemented as a standard Python package (in one example, the only dependency is the C++ library seqan for sequence alignment); of course, one of ordinary skill will recognize that other programming languages, data formats, and the like are possible and contemplated.

In one example, the exemplary variant caller relies on a pre-built error table (e.g., as described herein) for error correction. In order to generate the error table, the process collects a plurality of samples (e.g., several hundred samples or more) with data for the regions for calling. An error table can then be generated for a specific region (such as chr1:100-200) via the following exemplary command:

python -m kcall gen-table

--reference /path/to/hg19.fa
--output my_error-table.err
--from /directory/with/bam/files
-threads $NTHREADS
--region chr1:100-200

--dbsnp dbsnp.vcf

Alternatively, the process can provide a *.bed file:

python -m kcall gen-table

--reference /path/to/hg19.fa
--output my_error-table.err
--from /directory/with/bam/files
--threads $NTHREADS
--bed /path/to/my/bedfile.bed

--dbsnp dbsnp.vcf

Finally, with a list of *.bam files instead of a directory, the process can provide that list instead to --from:

python -m kcall gen-table

--reference /path/to/hg19.fa
--output my_error-table.err
--from/path/to/list-of-bam-files.txt
--threads $NTHREADS
--bed /path/to/my/bedfile.bed

--dbsnp dbsnp.vcf

If a user desires to parallelize the error table generation over several nodes in a cluster, the process can spawn a separate job for each region in the *.bed file. The process can then combine all of the generated pieces into a single table. Since the error table is a simple json format, the process can use the jq tool to do this:

# Assume all your error table pieces are stored in pieces/as json files.cat pieces/*.json|jq -s add>combined table.json”

With an error table generated, the process can run the Kcall variant caller with the following command:

python -m kcall call

--reference /path/to/hg19.fa
--errors my_error-table.json
--bam /path/to/sample.bam
--threads $NTHREADS
--bed /path/to/bed/file.bed
--output-json output.json
--output-vcf-full full.vcf

--output-vcf-snp snp.vcf

The exemplary variant caller can provide output in at least three formats, for example: json, vcf-snp, and vcf-full, under the corresponding flags shown above. The process may have any subset of these flags; if none are provided, the process outputs the vcf-snp format to standard out. The json format is generally the simplest, and simply yields a JSON file with a dictionary where each key is a string describing the region (such as “chr1:100-200”) and the value is either a string describing the no-call reason (if the region was no-called) or a dictionary with diplotype and confidence keys providing the sequences for the region. The vcf-full format outputs the same information as a VCF, where each region corresponds to exactly one row. Note that while information about no-calls is available from the VCFs (because the genotype GT field will be ./.), the no-call reason is available from the JSON output format. Finally, the vcf-snp format breaks up the output VCF via individual haplotype calls, joining together SNPS if they are closer than a few bases apart. This generates calls similar to GATK and Freebayes.

Once exemplary variant caller has generated calls, the process can compare them to another set of calls. For example, the variant caller may include an integrated comparison tool for this purpose, which finds base-by-base differences indexed by their location in the reference genome. This allows the process to compare VCFs with different output formats, so a call set can easily be compared to Freebayes, GATK1, or GATK2 call sets. In order to compare two VCFs, the following command can be used:

python -m kcall compare first_vcf.vcf second_vcf.vcf

--reference /path/to/hg19.fa
--output output.diff
--stats output.stats
--name $SAMPLE_NAME
--bed /path/to/bed/file.bed

The generated output is contained in two tab-separated tables (output.diff and output. stats) above. These two TSV files contain the differences between the two call sets and some statistics about the frequency of the differences, respectively.

Exemplary Architecture and Processing Environment:

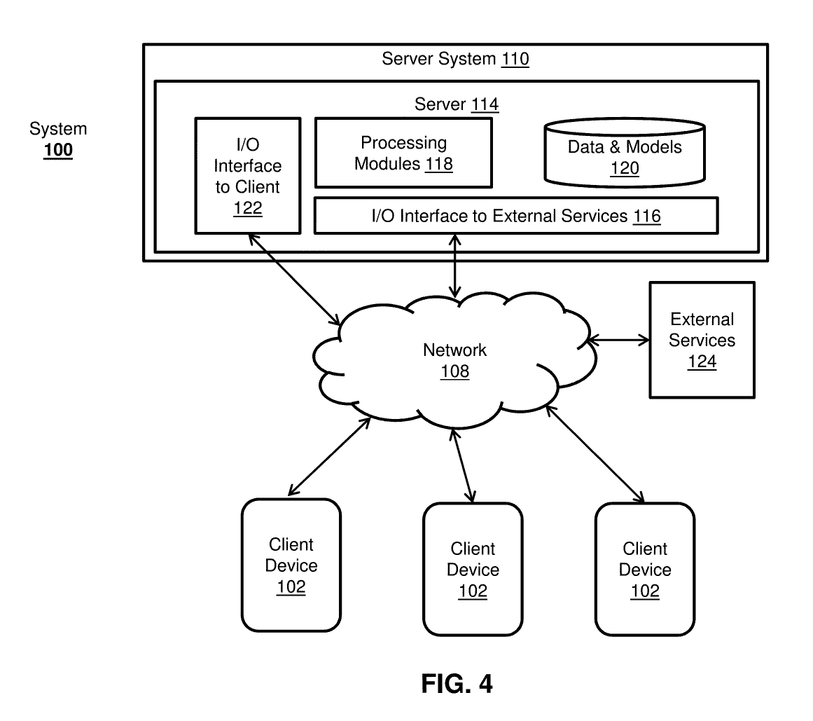

An exemplary environment and system in which certain aspects and examples of the systems and processes described herein may operate. As shown in FIG. 4, in some examples, the system can be implemented according to a client-server model. The system can include a client-side portion executed on a user device 102 and a server-side portion executed on a server system 110. User device 102 can include any electronic device, such as a desktop computer, laptop computer, tablet computer, PDA, mobile phone (e.g., smartphone), or the like.

User devices 102 can communicate with server system 110 through one or more networks 108, which can include the Internet, an intranet, or any other wired or wireless public or private network. The client-side portion of the exemplary system on user device 102 can provide client-side functionalities, such as user-facing input and output processing and communications with server system 110. Server system 110 can provide server-side functionalities for any number of clients residing on a respective user device 102. Further, server system 110 can include one or caller servers 114 that can include a client-facing I/O interface 122, one or more processing modules 118, data and model storage 120, and an I/O interface to external services 116. The client-facing I/O interface 122 can facilitate the client-facing input and output processing for caller servers 114. The one or more processing modules 118 can include various issue and candidate scoring models as described herein. In some examples, caller server 114 can communicate with external services 124, such as text databases, subscriptions services, government record services, and the like, through network(s) 108 for task completion or information acquisition. The I/O interface to external services 116 can facilitate such communications.

Server system 110 can be implemented on one or more standalone data processing devices or a distributed network of computers. In some examples, server system 110 can employ various virtual devices and/or services of third-party service providers (e.g., third-party cloud service providers) to provide the underlying computing resources and/or infrastructure resources of server system 110.

Although the functionality of the caller server 114 is shown in FIG. 4 as including both a client-side portion and a server-side portion, in some examples, certain functions described herein (e.g., with respect to user interface features and graphical elements) can be implemented as a standalone application installed on a user device. In addition, the division of functionalities between the client and server portions of the system can vary in different examples. For instance, in some examples, the client executed on user device 102 can be a thin client that provides only user-facing input and output processing functions, and delegates all other functionalities of the system to a backend server.

It should be noted that server system 110 and clients 102 may further include any one of various types of computer devices, having, e.g., a processing unit, a memory (which may include logic or software for carrying out some or all of the functions described herein), and a communication interface, as well as other conventional computer components (e.g., input device, such as a keyboard/touch screen, and output device, such as display). Further, one or both of server system 110 and clients 102 generally includes logic (e.g., http web server logic) or is programmed to format data, accessed from local or remote databases or other sources of data and content. To this end, server system 110 may utilize various web data interface techniques such as Common Gateway Interface (CGI) protocol and associated applications (or “scripts”), Java® “servlets,” i.e., Java® applications running on server system 110, or the like to present information and receive input from clients 102. Server system 110, although described herein in the singular, may actually comprise plural computers, devices, databases, associated backend devices, and the like, communicating (wired and/or wireless) and cooperating to perform some or all of the functions described herein. Server system 110 may further include or communicate with account servers (e.g., email servers), mobile servers, media servers, and the like.

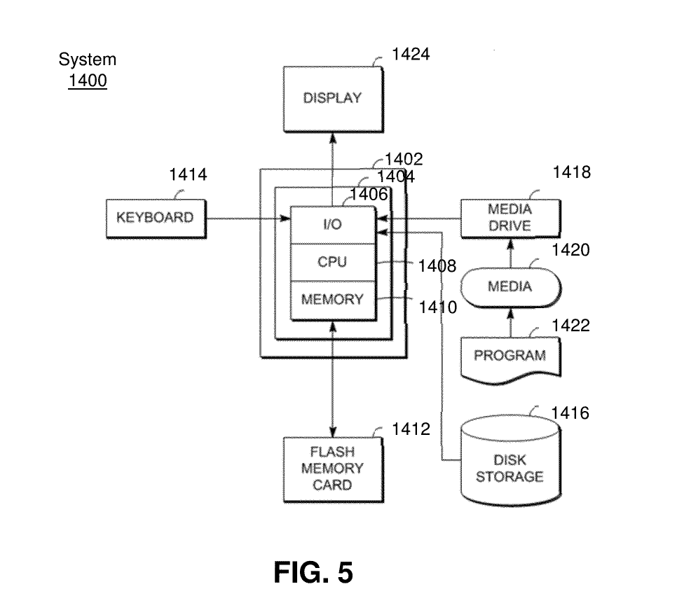

It should further be noted that although the exemplary methods and systems described herein describe use of a separate server and database systems for performing various functions, other embodiments could be implemented by storing the software or programming that operates to cause the described functions on a single device or any combination of multiple devices as a matter of design choice so long as the functionality described is performed. Similarly, the database system described can be implemented as a single database, a distributed database, a collection of distributed databases, a database with redundant online or offline backups or other redundancies, or the like, and can include a distributed database or storage network and associated processing intelligence. Although not depicted in the figures, server system 110 (and other servers and services described herein) generally include such art recognized components as are ordinarily found in server systems, including but not limited to processors, RAM, ROM, clocks, hardware drivers, associated storage, and the like (see, e.g., FIG. 5, discussed below). Further, the described functions and logic may be included in software, hardware, firmware, or combination thereof.

FIG. 5 depicts an exemplary computing system 1400 configured to perform any one of the above-described processes, including the various calling and scoring models. In this context, computing system 1400 may include, for example, a processor, memory, storage, and input/output devices (e.g., monitor, keyboard, disk drive, Internet connection, etc.). However, computing system 1400 may include circuitry or other specialized hardware for carrying out some or all aspects of the processes. In some operational settings, computing system 1400 may be configured as a system that includes one or more units, each of which is configured to carry out some aspects of the processes either in software, hardware, or some combination thereof.

FIG. 5 depicts computing system 1400 with a number of components that may be used to perform the above-described processes. The main system 1402 includes a motherboard 1404 having an input/output (“I/O”) section 1406, one or more central processing units (“CPU”) 1408, and a memory section 1410, which may have a flash memory card 1412 related to it. The I/O section 1406 is connected to a display 1424, a keyboard 1414, a disk storage unit 1416, and a media drive unit 1418. The media drive unit 1418 can read/write a computer-readable medium 1420, which can contain programs 1422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Python, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

What is claimed is:

1. A computer-implemented method for determining variants from a genome sample relative to a reference genomic sequence, the method comprising:
at an electronic device having at least one processor and memory:
accessing an error table of sequence data from previously sequenced samples;
determining a set of possible haplotypes from a set of collected reads from a genome sample;
generating a set of diplotypes based on the set of possible haplotypes and the error table, wherein the set of possible haplotypes is filtered by the error table;
scoring the set of diplotypes; and
outputting variants based on scoring the set of diplotypes.

2. The method of claim 1, further comprising:
generating a k-mer graph from a set of collected reads;
reducing the generated k-mer graph to a contiguous graph; and
generating the set of possible haplotypes from the contiguous graph.

3. The method of claim 1, wherein scoring the set of diplotypes further comprises determining a posterior probability for each diplotype.

4. The method of claim 1, further comprising generating the error table, wherein generating the error table comprises:
aligning reads to a reference sample;
determining sites where a read has a mismatch from the reference sample; and
adding sites that have a mismatch to the error table.

5. The method of claim 4, wherein generating the error table further comprises filtering sites from the error table that are not associated with sequencer error.

6. The method of claim 4, wherein generating the error table further comprises:
filtering sites from the error table that fail the threshold using one or more of a Hardy-Weinberg test, Bayes Factor test, or a Strand Bias Test.

7. A computer-implemented method for generating an error table of sequence data, the method comprising:
at an electronic device having at least one processor and memory:
determining a set of possible haplotypes from a set of collected reads from a genome sample;
aligning the set of collected reads to a reference sample;
determining sites where a read of the set of collected reads has a mismatch from the reference sample; and
adding sites that have a mismatch to an error table.

8. The method of claim 7, wherein determining the set of possible haplotypes comprises:
generating a k-mer graph from the set of collected reads;
reducing the generated k-mer graph to a contiguous graph; and
determining the set of possible haplotypes from the contiguous graph.

9. A non-transitory computer-readable storage medium comprising computer-executable instructions for
accessing an error table of sequence data from previously sequenced samples;
determining a set of possible haplotypes from a set of collected reads from a genome sample;
generating a set of diplotypes based on the set of possible haplotypes and the error table, wherein the set of possible haplotypes is filtered by the error table;
scoring the set of diplotypes; and
outputting variants based on scoring the set of diplotypes.

10. The non-transitory computer-readable storage medium of claim 9, further comprising:
generating a k-mer graph from a set of collected reads;
reducing the generated k-mer graph to a contiguous graph; and
generating the set of possible haplotypes from the contiguous graph.

11. The non-transitory computer-readable storage medium of claim 9, wherein scoring the set of diplotypes further comprises determining a posterior probability for each diplotype.

12. The non-transitory computer-readable storage medium of claim 9, further comprising generating the error table, wherein generating the error table comprises:
aligning reads to a reference sample;
determining sites where a read has a mismatch from the reference sample; and
adding sites that have a mismatch to the error table.

13. The non-transitory computer-readable storage medium of claim 12, wherein generating the error table further comprises filtering sites from the error table that are not associated with sequencer error.

14. The non-transitory computer-readable storage medium of claim 12, wherein generating the error table further comprises:
filtering sites from the error table that fail the threshold using one or more of a Hardy-Weinberg test, Bayes Factor test, or a Strand Bias Test.

15. A system comprising:
one or more processors;
memory; and
one or more programs, wherein the one or more programs are stored in the memory and configured to be executed by the one or more processors, the one or more programs including instructions for:
accessing an error table of sequence data from previously sequenced samples;
determining a set of possible haplotypes from a set of collected reads from a genome sample;
generating a set of diplotypes based on the set of possible haplotypes and the error table, wherein the set of possible haplotypes is filtered by the error table;
scoring the set of diplotypes; and
outputting variants based on scoring the set of diplotypes.

16. The system of claim 9, further comprising:
generating a k-mer graph from a set of collected reads;
reducing the generated k-mer graph to a contiguous graph; and
generating the set of possible haplotypes from the contiguous graph.

17. The system of claim 9, wherein scoring the set of diplotypes further comprises determining a posterior probability for each diplotype.

18. The system of claim 9, further comprising generating the error table, wherein generating the error table comprises:
aligning reads to a reference sample;
determining sites where a read has a mismatch from the reference sample; and
adding sites that have a mismatch to the error table.

19. The system of claim 18, wherein generating the error table further comprises filtering sites from the error table that are not associated with sequencer error.

20. The system of claim 18, wherein generating the error table further comprises:
filtering sites from the error table that fail the threshold using one or more of a Hardy-Weinberg test, Bayes Factor test, or a Strand Bias Test.
